(19) United States
(12) Patent Application Publication
(10) Pub. No.: US 2026/0117476 A1
(43) Pub. Date: Apr. 30, 2026

(54) METHOD AND SYSTEM FOR DETERMINING LIMIT SCOURING STATE OF RIVERBED IN DOWNSTREAM RIVER CHANNEL OF RESERVOIR GROUP

(71) Applicant: Bureau of Hydrology, Changjiang Water Resources Commission, Wuhan (CN)

(72) Inventors: Lingling Zhu, Wuhan (CN); Hua Ge, Wuhan (CN); Shengwei Li, Wuhan (CN); Bingjiang Dong, Wuhan (CN); Xiao Xiao, Wuhan (CN); Yongyang Fan, Wuhan (CN); Sixuan Li, Wuhan (CN); Chenggang Yang, Wuhan (CN); Chunyan Luo, Wuhan (CN); Yue Wang, Wuhan (CN); Chang Li, Wuhan (CN); Zhizhong Zhao, Wuhan (CN); Kebing Chen, Wuhan (CN); Ya Liu, Wuhan (CN); Juanjuan Fang, Wuhan (CN)

(21) Appl. No.: 19/344,693

(22) Filed: Sep. 30, 2025

Related U.S. Application Data
(63) Continuation-in-part of application No. 19/064,936, filed on Feb. 27, 2025, now abandoned.

(30) Foreign Application Priority Data
Mar. 1, 2024 (CN) 2024102329426

(51) Int. Cl. E02B 3/02; G01C 13/00

(52) U.S. Cl. CPC E02B 3/02; G01C 13/00

(57) ABSTRACT

A method and system for determining a limit scouring state of riverbed in downstream river channel of a reservoir group are provided. The method includes: collecting discharge data and cross-sectional prototype observation data of the downstream river channel of the reservoir group; establishing a correlation between discharge and a sediment carrying capacity indicator of a cross-section of a controlled hydrological station; calculating variation of the sediment carrying capacity indicator corresponding to dominant discharge; and determining and verifying the limit scouring state of the riverbed in the downstream river channel of the reservoir group. The method determines the limit scouring state of the riverbed in the river channel, and verifies the preliminary screening results based on the cross-section changes with the above determination, so as to provide technical support for mastering the development process of riverbed scouring and scouring trend prediction in the dam downstream river channel of the reservoir group.

### CROSS-REFERENCE TO RELATED APPLICATIONS

This application is a continuation-in-part of U.S. patent application Ser. No. 19/064,936 , filed on Feb. 27, 2025, which claims the priority to Chinese Patent Application No. 202410232942.6, filed on Mar. 1, 2024, both of which are herein incorporated by reference in their entirety.

### TECHNICAL FIELD

The disclosure relates to the field of hydraulics and river dynamics technologies, and more particularly to a method and system for determining a limit scouring state of a riverbed in a downstream river channel of a reservoir group.

### BACKGROUND

The reservoir group is constructed and operated to intercept sediment in the basin layer by layer, and change a natural runoff process at the same time. A duration of middle water is greatly extended, resulting in a downstream river channel being in a state of clear water scouring for a long time. The riverbed is constantly scoured and cut, resulting in collapse of both banks, erosion of beaches, and significant drop of middle and low water levels, which has a certain adverse impact on the river channel function. Therefore, the prediction of a scouring development process and a limit state of the downstream river channel of the reservoir group is particularly important. In the past, some studies have been conducted on the limit scouring state of the riverbed from the perspectives of riverbed coarsening and slope adjustment, but it is relatively difficult to obtain rich observation data on riverbed sand coarsening and bed slope, and there is no a strict standard for the degree of the riverbed sand coarsening in the limit scouring state, resulting in a large deviation between the predicted limit scouring state of the riverbed and the actual situation, which is not enough to support the medium and long-term protection and management planning of the downstream river channel of the reservoir group.

In order to reasonably and simply evaluate the scouring state of the downstream river channel of the reservoir group and determine whether the river channel has appeared or entered the limit scouring state, it is necessary to recognize a premise that the sediment is in an unsaturated state for a long time, change the measurement standards such as the morphological changes of the passive adjustment of the riverbed, and instead start from the hydrodynamic conditions that actively shape the riverbed morphology. According to the changes in the hydrodynamic intensity during the riverbed scouring process, it is possible to determine whether the riverbed has entered the limit scouring state, thereby providing more sufficient basis and support for the medium and long-term protection and management of the downstream river channel of the reservoir group.

### SUMMARY

An objective of embodiments of the disclosure is to provide a method and system for determining a limit scouring state of a riverbed in a downstream river channel of a reservoir group, which can be applied to evaluate riverbed scouring intensity, range and development process in the downstream river channel of the reservoir group, to thereby provide basic basis and technical support for the protection, planning and treatment of the downstream river channel of the reservoir group.

In order to achieve the above objective, the disclosure provides the following technical solutions.

In the first aspect, the embodiments of the disclosure provide a method for determining a limit scouring state of a riverbed in a downstream river channel of a reservoir group, including the following steps:
step 1, collecting discharge data and cross-sectional prototype observation data of the downstream river channel of the reservoir group;
step 2, establishing a correlation between discharge of a cross-section of a controlled hydrological station and a sediment carrying capacity indicator of the cross-section of the controlled hydrological station;
step 3, calculating variation of the sediment carrying capacity indicator corresponding to dominant discharge;
step 4, determining and verifying the limit scouring state of the riverbed in the downstream river channel of the reservoir group; and
step 5, optimizing, in response to the riverbed entering the limit scouring state, an intake elevation of a water intake facility located on a riverbed of the downstream river channel of the reservoir group to make a water intake guarantee rate of the water intake facility of at least 97%; or
controlling, in response to the riverbed doing not enter the limit scouring state, a safety depth of the water intake facility to make the water intake guarantee rate of the water intake facility at least be 97%.

In an embodiment, the step 1 includes:
step 11, collecting measured discharge data and cross-sectional data of the controlled hydrological station in the downstream river channel of the reservoir group, and organizing a measured discharge velocity data and water depth data; and
step 12, superimposing a cross-sectional change diagram of the controlled hydrological station according to the cross-sectional data, calculating a discharge area and an average riverbed elevation under a bankfull stage according to the measured discharge data, the measured discharge velocity data and the water depth data, drawing time-varying hydrographs of the discharge area and the average riverbed elevation under the bankfull stage, and preliminarily analyzing a scouring state of the cross-section and a near-stable time of the scouring state of the cross-section.

In an embodiment, the discharge data and cross-sectional data of the controlled hydrological station in the downstream river channel of the reservoir group are measured by a global navigation satellite system (GNSS) and a walking acoustic doppler current profiler (ADCP) at a frequency of no less than 100 times per year.

In an embodiment, the step 2 includes:

1step 21, calculating the sediment carrying capacity indicator U³/h of the cross-section of the controlled hydrological station, and establishing the correlation between the discharge of the cross-section of the controlled hydrological station and the sediment carrying capacity indicator of the cross-section of the controlled hydrological station to draw a correlation curve diagram of Q U³/h; wherein U represents an average discharge velocity of the cross-section, in meter per second (m/s), h represents an average water depth of the cross-section, in meter (m), and Q represents the discharge of the cross-section, in cubic meter per second (m³/s);
step 22, drawing a curve diagram of Q Q^{m}JP of the controlled hydrological station by using a Makkaveev method, wherein m represents a sediment transport coefficient, J represents a bed slope, P represents discharge frequency, m, J and P are dimensionless parameters, and Q^{m}JP comprehensively represents a sediment transport capacity of water flow; and calculating the dominant discharge of a dam downstream river reach after storage and operation of the reservoir group; and
step 23, identifying, based on the correlation curve diagram of Q U³/h, sediment carrying capacity indicators corresponding to the dominant discharge year by year to obtain annual values of the sediment carrying capacity indicators.

In an embodiment, the step 3 includes:
step 31, selecting, according to a duration of the dominant discharge, a 10-year period with strong channel formation effect to calculate a time period average value of the sediment carrying capacity indicators corresponding to the dominant discharge;
step 32, calculating 5-year moving average values of the sediment carrying capacity indicators corresponding to the dominant discharge according to a hysteresis response principle of riverbed scouring and silting adjustment; and
step 33, drawing curves of the annual values, the 5-year moving average values and the time period average value of the sediment carrying capacity indicators corresponding to the dominant discharge.

In an embodiment, the step 4, includes:

step 41, analyzing the curves obtained in the step 33, in response to the curves of the annual values, the 5-year moving average values and the time period average value of the sediment carrying capacity indicators corresponding to the dominant discharge beginning to coincide at a coincided point, determining that a riverbed of a reach where the controlled hydrological station is located enters the limit scouring state from a time point corresponding to the coincided point; and in response to the curves of the annual values, the 5-year moving average values and the time period average value of the sediment carrying capacity indicators corresponding to the dominant discharge not coinciding, determining that scouring at the reach where the controlled hydrological station is located continue to develop and has not entered the limit scouring state;
step 42, comparing the near-stable time in the step 12 and the time point in the step 41, in response to the near-stable time and the time point being close, further determining that the riverbed reaches the limit scouring state; and
step 43, obtaining a duration for the downstream river channel of the reservoir group to reach the limit scouring state.

In an embodiment, the optimizing an intake elevation of a water intake facility located on a riverbed of the downstream river channel of the reservoir group to make a water intake guarantee rate of the water intake facility of at least 97% includes:
calculating a submergence depth of a water intake port of the water intake facility; where the submergence depth is a vertical distance between the water intake port and a low-water level corresponding to a 97% water intake guarantee rate of the water intake facility; and
in response to the submergence depth being less than 1.0 meter (m), lowering the intake elevation of the water intake facility to 1.5 m below the low-water level to ensure the 97% water intake guarantee rate of the water intake facility.

In an embodiment, the controlling a safety depth of the water intake facility to make the water intake guarantee rate of the water intake facility at least be 97% includes:
lowering the intake elevation of the water intake facility to increase the safety depth to 2 m, to thereby ensure the 97% water intake guarantee rate of the water intake facility during a process of the riverbed continuing to scour to the limit scouring state.

In an embodiment, the step 5 further includes:
determining, in response to the riverbed entering the limit scouring state, coordinates of a main channel centerline in the downstream river channel based on a latest riverbed topography map and a navigation reference plane, and defining, according to the coordinates of the main channel centerline, a navigable channel having a navigable depth of at least 1.8 m and a width of at least 50 m; and
superposing the navigable channel onto a satellite image map to obtain a superposed image map; and displaying the superposed image map on a display screen to present information associated with the navigable channel, to thereby navigate a ship on the navigable channel ensure navigation safety of the ship.

In the second aspect, the embodiments of the disclosure provides a system for determining a limit scouring state of a riverbed in a downstream river channel of a reservoir group, including a data collection module, a correlation establishment module, a calculation module and a determination module.

The data collection module is configured to collect the discharge data and the cross-sectional prototype observation data of the downstream river channel of the reservoir group.

The correlation establishment module is configured to establish the correlation between the discharge of the cross-section of the controlled hydrological station and the sediment carrying capacity indicator of the cross-section of the controlled hydrological station.

The calculation module is configured to calculate the variation of the sediment carrying capacity indicator corresponding to the dominant discharge.

The determination module is configured to determine and verify the limit scouring state of the riverbed in the downstream river channel of the reservoir group.

In the third aspect the embodiments of the disclosure provides a non-transitory computer-readable storage medium. The non-transitory computer-readable storage medium has a program code stored therein, and the program code is configured to be executed by a processor to implement steps of the above method for determining the limit scouring state of the riverbed in the downstream river channel of the reservoir group.

In an exemplary embodiment, each of the data collection module, the correlation establishment module, the calculation module and the determination module is embodied by at least one processor and at least one memory coupled to the at least one processor, and the at least one memory stores programs executable by the at least one processor.

Compared to the related art, the beneficial effects of the disclosure are as follows.

The disclosure is in line with the actual situation of long-term scouring of the riverbed in the dam downstream river channel under the effect of water storage and sediment interception of the reservoir group. The disclosure collects the discharge data and the cross-sectional prototype observation data of the downstream river channel of the reservoir group, superimposes the changes in the scouring and silting, the discharge area and the average riverbed elevation of the typical cross-section of the river channel, preliminarily determines the limit scouring state and occurrence period of the riverbed, calculates the dominant discharge of the riverbed and the sediment carrying capacity indicator of the cross-section of the controlled hydrological station, screens the hydrological process with a strong channel formation effect based on the duration of the dominant discharge, establishes the correlation between the dominant discharge and the sediment-carrying capacity indicator, extracts the sediment carrying capacity indicators corresponding to the dominant discharge, determines the limit scouring state of the riverbed in the river channel according to the change law of the annual values, the 5-year moving average values and the time period average value during the hydrological process with the strong channel formation effect, and verifies the preliminary screening results based on the cross-section changes with the above determination, so as to provide technical support for mastering the development process of riverbed scouring and scouring trend prediction in the dam downstream river channel of the reservoir group. The calculation data is sufficient, the method mechanism is clear, the implementation process is clear, and the technical means are feasible.

### BRIEF DESCRIPTION OF DRAWINGS

In order to more clearly describe technical solutions of embodiments of the disclosure, drawings required in the embodiments of the disclosure will be briefly introduced below. It should be understood that the following drawings merely show some of the embodiments of the disclosure and therefore should not be regarded as limiting the scope. For those skilled in the art, other related drawings can be obtained based on these drawings without creative work.

FIG. 1 illustrates a calculation flowchart of a method for determining a limit scouring state of a riverbed in a downstream river channel of a reservoir group according to an embodiment of the disclosure.

FIG. 2A illustrates a schematic superimposition diagram of a cross-section of a ZC hydrological station of the downstream river channel of the reservoir group.

FIG. 2B illustrates a schematic superimposition diagram of a cross-section of an SS hydrological station of the downstream river channel of the reservoir group.

FIG. 3A illustrates a time-varying diagram of a discharge area and an average riverbed elevation of the cross-section of the ZC hydrological station of the downstream river channel of the reservoir group under a bankfull stage.

FIG. 3B illustrates a time-varying diagram of a discharge area and an average riverbed elevation of the cross-section of the SS hydrological station of the downstream river channel of the reservoir group under a bankfull stage.

FIG. 4A illustrates a measured curve diagram of Q U³/h of the ZC hydrological station of the downstream river channel of the reservoir group.

FIG. 4B illustrates a measured curve diagram of Q U³/h of the SS hydrological station of the downstream river channel of the reservoir group.

FIG. 5A illustrates a curve diagram of Q Q^{m}JP of the ZC hydrological station of the downstream river channel of the reservoir group.

FIG. 5B illustrates a curve diagram of Q Q^{m}JP of the SS hydrological station of the downstream river channel of the reservoir group.

FIG. 6A illustrates a curve diagram of annual values, 5-year moving average values and an average value during a strong scouring period of sediment carrying capacity indicators corresponding to dominant discharge of the ZC hydrological station of the downstream river channel of the reservoir group.

FIG. 6B illustrates a curve diagram of annual values, 5-year moving average values and an average value during a strong scouring period of sediment carrying capacity indicators corresponding to dominant discharge of the SS hydrological station of the downstream river channel of the reservoir group.

FIG. 7 illustrates a block diagram of a system for determining the limit scouring state of the riverbed in the downstream river channel of the reservoir group according to an embodiment of the disclosure.

### DETAILED DESCRIPTION OF EMBODIMENTS

The technical solutions in the embodiments of the disclosure will be described below in conjunction with the drawings in the embodiments of the disclosure. It should be noted that similar reference signs and letters represent similar items in the following drawings, thus once an item is defined in a drawing, it does not need to be further defined and explained in the subsequent drawings.

The terms “comprise”, “include” or any other variation thereof are intended to encompass non-exclusive inclusion, such that a process, method, article, or apparatus that includes a list of elements includes not only those elements, but also other elements not explicitly listed, or elements inherent to such process, method, article, or apparatus. In the absence of further limitations, an element defined by the phrase “comprising a . . . ” does not exclude the presence of additional identical elements in the process, method, article, or apparatus that includes the element.

The terms “first” and “second” are only used to distinguish an entity or operation from another entity or operation, and should not be understood as indicating or implying relative importance, nor should they be understood as requiring or implying any such actual relationship or order between these entities or operations.

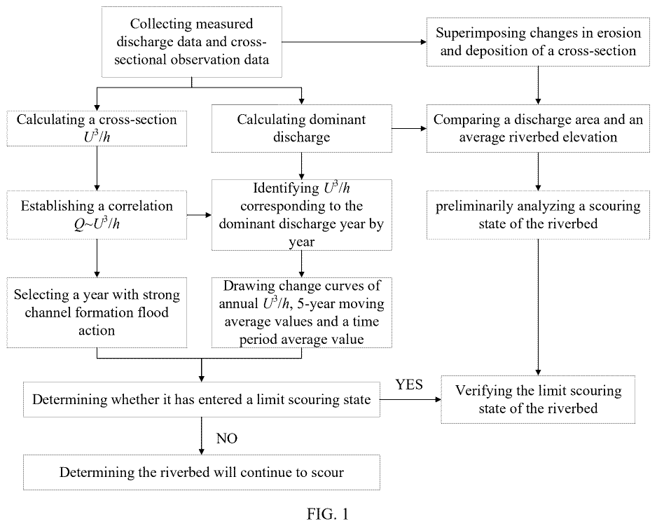

Please referring to FIG. 1, the disclosure discloses a method for determining a limit scouring state of a riverbed in a downstream river channel of a reservoir group, which includes the following steps 1-4.

In step 1, discharge data and cross-sectional prototype observation data of the downstream river channel of the reservoir group are collected, which is achieved by the following steps 11-12.

In step 11, measured discharge data and cross-sectional data of a controlled hydrological station in the downstream river channel of the reservoir group are collected, and measured velocity and water depth data are organized.

In step 12, a cross-sectional change diagram of the controlled hydrological station is superimposed according to the cross-sectional data, a discharge area and an average riverbed elevation under a bankfull stage are calculated according to the measured discharge data, the measured discharge velocity data and the water depth data, time-varying hydrographs of the discharge area and the average riverbed elevation under the bankfull stage are drawn, and a scouring state of the cross-section and a near-stable time of the scouring state of the cross-section are preliminarily analyzed.

In step 2, a correlation between discharge of a cross-section of a controlled hydrological station and a sediment carrying capacity indicator of the cross-section of the controlled hydrological station is established, which is achieved through the following steps 21-23.

In step 21, the sediment carrying capacity indicator U³/h of the cross-section of the controlled hydrological station is calculated, the correlation between the discharge the cross-section of the controlled hydrological station and the sediment carrying capacity indicator at a control cross-section is established, and a correlation curve diagram of Q U³/h is drawn. U represents an average flow velocity at the cross-section, in m/s, h represents an average water depth at the cross-sectional, with a unit of m, and Q represents the discharge at the cross-sectional with a unit of m³/s.

In step 22, a curve diagram of Q Q^{m}JP of the controlled hydrological station is drawn by using a Makkaveev method, where m represents a sediment transport coefficient, J represents a bed slope, P represents discharge frequency, and m, J and P are dimensionless parameters; and Q^{m}JP comprehensively represents a sediment transport capacity of water flow. A dominant discharge of the downstream river channel of a dam is calculated after storage and operation of the reservoir group.

In step 23, sediment carrying capacity indicators corresponding to the dominant discharge is identified year by year based on the correlation curve diagram of Q U³/h to obtain annual values of the sediment carrying capacity indicators.

In step 3, variation of the sediment carrying capacity indicator corresponding to the dominant discharge is calculated, which is achieved through the following steps 31-33.

In step 31, a 10-year period with a strong channel formation effect is selected according to a duration of the dominant discharge, to calculate a time period average value of the sediment carrying capacity indicators corresponding to the dominant discharge.

In step 32, 5-year moving average values of the sediment carrying capacity indicators corresponding to the dominant discharge are calculated according to a hysteresis response principle of riverbed scouring and silting adjustment.

In step 33, curves of the annual values, the 5-year moving average values and the time period average value of the sediment carrying capacity indicators corresponding to the dominant discharge are drawn.

In step 4, the limit scouring state of the riverbed in the downstream river channel of the reservoir group is determined and verified, which is achieved through the following steps 41-43.

In step 41, the curves obtained in step 33 are analyzed. In response to the curves of the annual values, the 5-year moving average values and the time period average value of the sediment carrying capacity indicators corresponding to the dominant discharge beginning to coincide at a coincided point, it indicates that a riverbed of a reach where the controlled hydrological station is located enters the limit scouring state from a time point of the coincided point. In response to the curves of the annual values, the 5-year moving average values and the time period average value of the sediment carrying capacity indicators corresponding to the dominant discharge not coinciding, it indicates that scouring at the reach where the controlled hydrological station is located continue to develop and has not yet entered the limit scouring state.

In step 42, the near-stable time in the step 12 and the time point in the step 41 are compared, when the near-stable time and the time point are close, it further indicates that the riverbed enters the limit scouring state.

In step 43, a duration for the downstream river channel of the reservoir group to reach the limit scouring state is obtained.

The specific steps of the embodiment are as follows.

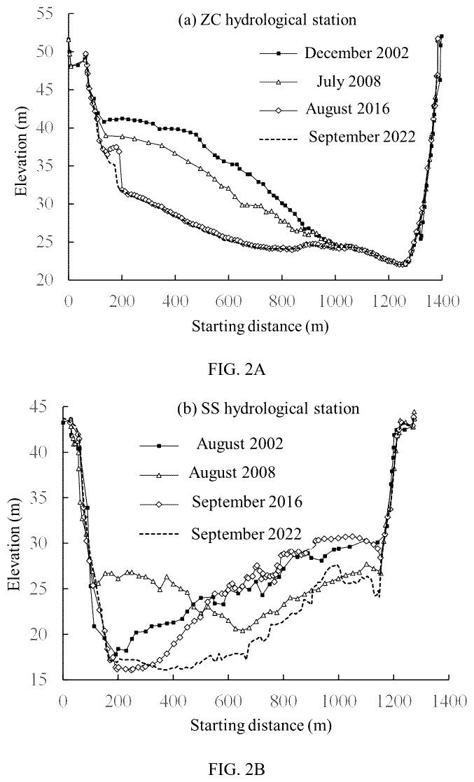

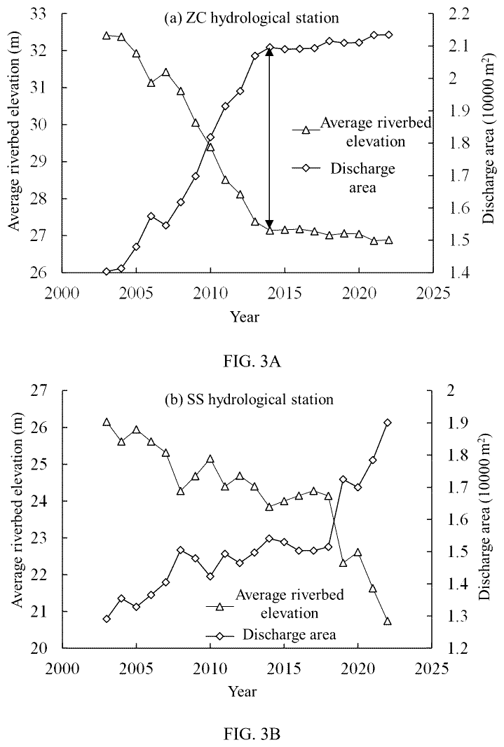

In step 1, observation data of about 20 years from 2002 to 2022 such as measured discharge data, daily average discharge data, bed slope data, and large cross-section data of two controlled hydrological stations within 150 kilometers (km) of downstream of a reservoir group in a certain basin is collected. The cross-sectional change diagrams of the two controlled hydrological stations are superimposed as shown in FIG. 2A and FIG. 2B. A discharge area and an average riverbed elevation under a bankfull stage are calculated, time-varying hydrographs of the discharge area and the average riverbed elevation under the bankfull stage are drawn as shown in FIG. 3A and FIG. 3B. A scouring state of the cross-section and a near-stable time of the scouring state of the cross-section are preliminarily analyzed. Specifically, the large cross-section of the ZC hydrological station remained stable in shape from 2016 to 2022, the change rates of the discharge area and the average riverbed elevation of the cross-section under the bankfull stage have slowed down significantly after 2014. It is preliminarily determined that a riverbed of a reach where the ZC hydrological station is located has entered the limit scouring state since 2014. The changes in the SS hydrological station are different from that of the ZC hydrological station. From 2002 to 2022, the cross-section has always been in a state of scouring adjustment. The change rates of the discharge area and the average riverbed elevation of the cross-section under the bankfull stage show a process of first increasing, then decreasing, and then increasing. It is preliminarily determined that a riverbed of a reach where the SS hydrological station is located has not yet entered the limit scouring state.

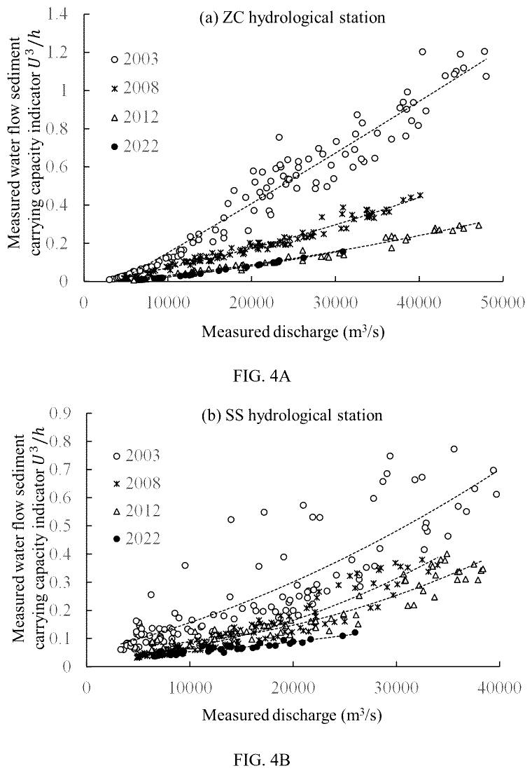

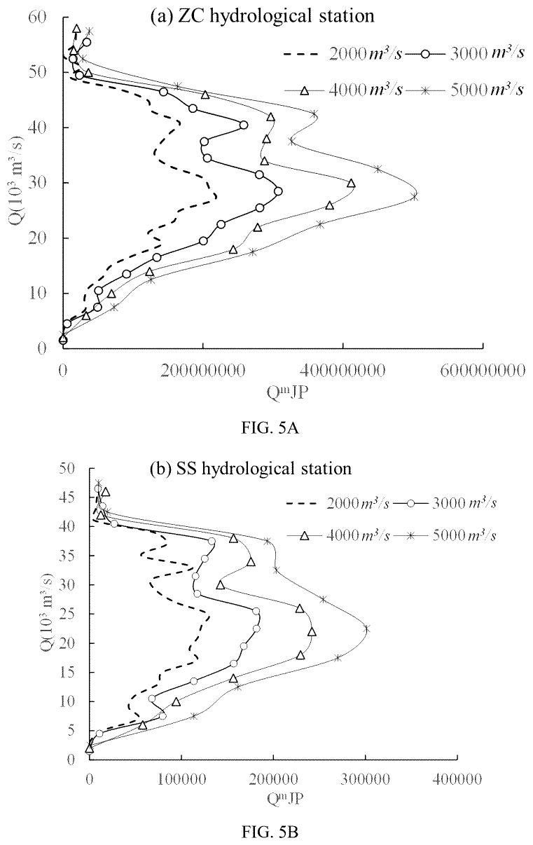

In step 2, the sediment carrying capacity indicators U³/h of the cross-sections on the ZC hydrological station and the SS hydrological station are calculated based on the measured discharge data from 2003 to 2022, and change curves (i.e., the correlation curve diagram of Q U³/h) of the sediment carrying capacity indicators U³/h with the discharge Q are drawn as shown in FIG. 4A and FIG. 4B. The curve diagrams of Q Q^{m}JP of the ZC hydrological station and the SS hydrological station from 2003 to 2022 after the operation of the reservoir group are calculated and drawn using the average daily discharge and the bed slopes of the stations based on the Makkaveev method, and the curve diagrams of Q Q^{m}JP are shown in FIG. 5A and FIG. 5B. The corresponding dominant discharges are 28000 m³/s and 23000 m³/s, respectively. The sediment carrying capacity indicators corresponding to the dominant discharges of the two hydrological stations are identified year by year comparing the correlation shown in FIG. 4A and FIG. 4B.

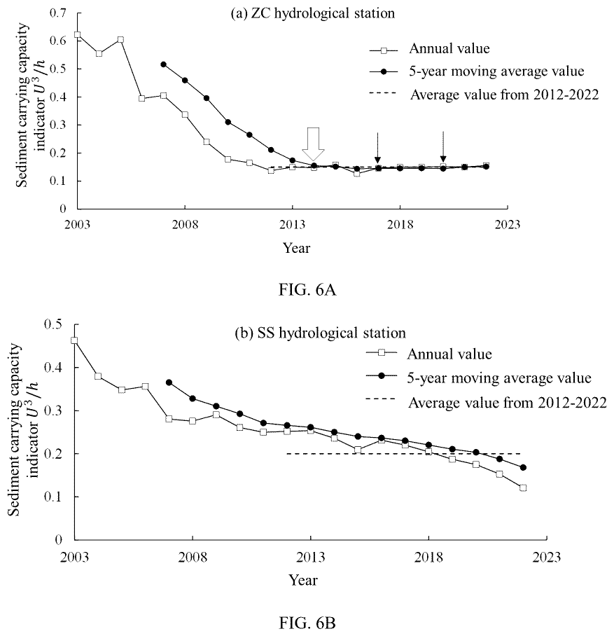

In step 3, durations of the inflow flow exceeding the dominant discharge at the ZC hydrological station and the SS hydrological station year by year are counted, a 10-year moving average values of the durations are calculated, and 10-year hydrological series with a longer duration of dominant discharge and a strong channel formation effect are screened out as 2013-2022. A time period average value of the sediment-carrying capacity indicators corresponding to the dominant discharge for each hydrological station from 2013 to 2022 is calculated. 5-year moving average values of the sediment carrying capacity indicators corresponding to the dominant discharge are calculated according to the hysteresis response principle of riverbed scouring and silting adjustment. Curves of annual values, the 5-year moving average values and 10-year average values (i.e., the time period average value) with strong channel formation effect of the sediment carrying capacity indicators corresponding to the dominant discharge are drawn as shown in FIG. 6A and FIG. 6B.

In step 4, the curves in FIG. 6A and FIG. 6B are analyzed. Since 2014, the curves of the annual values, the 5-year moving average values and the time period average value of the sediment carrying capacity indicators corresponding to the dominant discharge of the ZC hydrological station begin to coincide at a coincided point, it indicates that the riverbed of the reach where the ZC hydrological station is located has entered the limit scouring state from a time point of the coincided point. The curves of the sediment carrying capacity indicators of the dominant discharge of the SS hydrological station do not coincide, it indicates that the scouring of the reach where the SS hydrological station is located will continue to develop and has not yet entered the limit scouring state. The near-stable time in the step 12 and the time point in the step 41 are compared, the time obtained by both for the scouring of the ZC hydrological station to the limit state is 2014, further indicating that the riverbed in the reach where the station is located has entered the limit scouring state, and the duration for the riverbed to reach the limit scouring state is 11 years. The riverbed of the river reach where the SS hydrological station is located has not yet entered the limit scouring state, and the scouring will continue to develop.

In an embodiment, when the riverbed enters the limit scouring state, the following river channel management measures will be executed.

1. An intake elevation of an existing water intake facility is optimized. A submergence depth of a water intake port of the water intake facility is calculated. The submergence depth is a vertical distance between the water intake port and a low-water level corresponding to a 97% water intake guarantee rate of the water intake facility. When the submergence depth is less than 1.0 m, the intake elevation of the intake structure is lowered to 1.5 m below the low-water level. This ensures that at least 0.5 m of safety depth is maintained during pump operation, thereby restoring and maintaining a 97% water intake guarantee rate over the long term. The water intake guarantee rate refers to the percentage of years that a water intake facility can successfully obtain the required water volume under design conditions, compared to the total number of years. The water intake facility refers to a hydraulic structure located on the bank or riverbed of the downstream river channel of the reservoir group, designed to withdraw water from the river for purposes such as municipal water supply, irrigation, industry, or hydropower generation. It typically includes an intake port (e.g., bellmouth or trash rack), pump station, and connecting pipelines. The elevation of the intake port is critical for ensuring stable water withdrawal, especially under low-flow conditions. The safety depth refers to the vertical distance between the intake elevation (i.e., a bottom elevation of the water intake bellmouth or trash rack) and the low-water level corresponding to a 97% water intake guarantee rate. This depth must be maintained at no less than 0.5 m during pump operation to prevent air entrainment, cavitation, and unstable flow conditions. The safety depth serves as a design margin to ensure reliable and safe water withdrawal under long-term operating conditions. The low-water level refers specifically to the design low-water level corresponding to a 97% water intake guarantee rate. This level is determined through frequency analysis of long-term (e.g., 20-year or longer) daily discharge data from a hydrological station in the river reach. It represents the water level that is equaled or exceeded 97% of the time under natural or regulated flow conditions, and serves as the hydraulic design basis for water intake facilities.

2. Based on a latest riverbed topography map (acquired in step 1) and a predefined navigation reference plane, a geographic information system (GIS) is used to calculate coordinates of a main channel centerline that satisfies a minimum navigable depth of 1.8 m and a width of at least 50 m. Subsequently, the navigable channel is superposed onto a satellite image map to obtain a superposed image map; and the superposed image map is displayed on a display screen to present information associated with the navigable channel, to thereby navigate a ship on the navigable channel ensure navigation safety of the ship. This dynamically marks the navigable waterway and ensures safe vessel navigation.

In an embodiment, when the riverbed does not enter the limit scouring state, the safety depth of the water intake facility needs to be increased. During the engineering design phase, the design elevation of the water intake port is set at no less than 2.5 m below the low-water level corresponding to a 97% water intake guarantee rate. This increases the safety depth from the conventional 0.5 m to 2.0 m. The additional safety depth accommodates continued riverbed degradation over the next 10 to 15 years, thereby ensuring that the water intake guarantee rate remains no less than 97% throughout the entire process until the riverbed eventually reaches the limit scouring state.

In an embodiment, the discharge data and the cross-sectional data is measured by using an assault boat equipped with a GNSS and a walking ADCP. The measurement frequency is no less than 100 times per year to capture both short-term fluctuations and long-term trends in riverbed evolution. The GNSS is used for precise positioning of measurement cross-sections, while the ADCP synchronously acquires velocity profiles and water depth data. This configuration significantly improves the spatial and temporal resolution and accuracy of data collection, thereby providing high-quality input for subsequent determination of the scouring state.

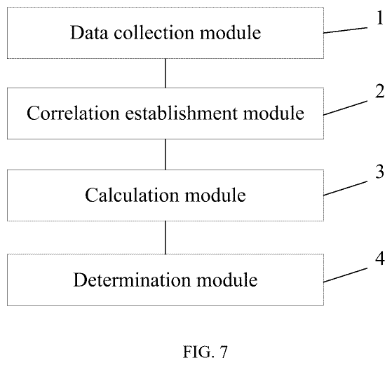

As shown in FIG. 7, the embodiments of the disclosure provide a system for determining a limit scouring state of a riverbed in a downstream river channel of a reservoir group, including a data collection module 1, a correlation establishment module 2, a calculation module 3 and a determination module 4.

The data collection module 1 is configured to collect discharge data and cross-sectional prototype observation data of the downstream river channel of the reservoir group.

The correlation establishment module 2 is configured to establish a correlation between discharge of a cross-section of a controlled hydrological station and a sediment carrying capacity indicator of the cross-section of the controlled hydrological station.

The calculation module 3 is configured to calculate variation of the sediment carrying capacity indicator corresponding to dominant discharge.

The determination module 4 is configured to determine and verify the limit scouring state of the riverbed in the downstream river channel of the reservoir group.

The embodiments of the disclosure provide a computer-readable storage medium, the computer-readable storage medium stores a program code therein, and the program code is configured to be executed by a processor to implement the steps of the above method for determining the limit scouring state of the riverbed in the downstream river channel of the reservoir group.

Those skilled in the art will appreciate that the embodiments of the disclosure may be provided as a method, a system, or a computer program product. Therefore, the disclosure may take the form of a complete hardware embodiment, a complete software embodiment, or an embodiment combining software and hardware. Moreover, the disclosure may take the form of a computer program product implemented on one or more computer-usable storage medium (including but not limited to disk storage, compact disc read-only memory abbreviated as CD-ROM, and optical storage) containing computer-usable program codes.

The disclosure is described with reference to the flowchart and/or block diagram of the method, device (system), and computer program product according to the embodiment of the disclosure. It should be understood that each process and/or block in the flowchart and/or block diagram, as well as the combination of the process and/or block in the flowchart and/or block diagram can be implemented by computer program instructions. These computer program instructions can be provided to a processor of a general-purpose computer, a special-purpose computer, an embedded processor, or other programmable data processing device to generate a machine, so that the instructions executed by the processor of the computer or other programmable data processing device generate a device for implementing the functions specified in one process or multiple processes in the flowchart and/or one block or multiple boxes in the block diagram.

These computer program instructions may also be stored in a computer-readable memory that can direct a computer or other programmable data processing device to operate in a specific manner, so that the instructions stored in the computer-readable memory produce a manufactured product including an instruction device that implements the functions specified in one or more processes in the flowchart and/or one or more blocks in the block diagram.

These computer program instructions may also be loaded onto a computer or other programmable data processing device, so that a series of operational steps are executed on the computer or other programmable device to produce a computer-implemented process, thereby the instructions executed on the computer or other programmable device provide steps for implementing the functions specified in one or more processes in the flowchart and/or one or more blocks in the block diagram.

In a typical configuration, a computing device includes one or more processors (CPU), input/output interfaces, network interfaces, and memory.

The memory may include a non-permanent memory, a random-access memory (RAM) and/or a non-transitory memory in the computer-readable medium, such as read-only memory (ROM) or flash RAM. The memory is an example of the computer-readable medium.

The computer readable medium include permanent and non-permanent, removable and non-removable media that can be implemented by any method or technology to store information. Information can be computer readable instructions, data structures, program modules or other data. Examples of the computer storage medium include, but are not limited to, phase-change memory (PCAM), static random access memory (SRAM), dynamic random access memory (DRAM), other types of random-access memory (RAM), read-only memory (ROM), electrically erasable programmable read-only memory (EEPROM), flash memory or other memory technology, compact disk read-only memory (CD-ROM), digital versatile disk (DVD) or other optical storage, magnetic cassettes, magnetic tape magnetic disk storage or other magnetic storage devices or any other non-transmission medium that can be used to store information that can be accessed by a computing device. As defined herein, the computer readable medium does not include transitory computer readable medium (transitory media), such as modulated data signals and carrier waves.

The above description is only an embodiment of the disclosure and is not intended to limit the scope of protection of the disclosure. For those skilled in the art, the disclosure may have various modifications and variations. Any modification, equivalent replacement and improvement made within the spirit and principle of the disclosure shall be included in the scope of protection of the disclosure.

What is claimed is:

1. A method for determining a limit scouring state of a riverbed in a downstream river
channel of a reservoir group, comprising:
step 1, collecting discharge data and cross-sectional prototype observation data of the downstream river channel of the reservoir group;
step 11, collecting measured discharge data and cross-sectional data of a controlled hydrological station in the downstream river channel of the reservoir group, and organizing measured discharge velocity data and water depth data; and
step 12, superimposing a cross-sectional change diagram of the controlled hydrological station according to the cross-sectional data, calculating a discharge area and an average riverbed elevation under a bankfull stage according to the measured discharge data, the measured discharge velocity data and the water depth data, drawing time-varying hydrographs of the discharge area and the average riverbed elevation under the bankfull stage, and preliminarily analyzing a scouring state of the cross-section and a near-stable time of the scouring state of the cross-section;
step 2, establishing a correlation between discharge of a cross-section of the controlled hydrological station and a sediment carrying capacity indicator of the cross-section of the controlled hydrological station;
step 21, calculating the sediment carrying capacity indicator U³/h of the cross-section of the controlled hydrological station, and establishing the correlation between the discharge of the cross-section of the controlled hydrological station and the sediment carrying capacity indicator of the cross-section of the controlled hydrological station to draw a correlation curve diagram of Q U³/h, wherein U represents an average discharge velocity of the cross-section, in m/s, h represents an average water depth of the cross-section, in m, and Q represents the discharge of the cross-section, in m³/s;
step 22, drawing a curve diagram of Q Q^{m}JP of the controlled hydrological station by using a Makkaveev method, wherein m represents a sediment transport coefficient, J represents a bed slope, P represents discharge frequency, m, J and P are dimensionless parameters, and Q^{m}JP comprehensively represents a sediment transport capacity of water flow; and calculating dominant discharge of a dam downstream river reach after storage and operation of the reservoir group; and
step 23, identifying, based on the correlation curve diagram of Q U³/h, sediment carrying capacity indicators corresponding to the dominant discharge year by year to obtain annual values of the sediment carrying capacity indicators;
step 3, calculating variation of the sediment carrying capacity indicator corresponding to the dominant discharge;
step 31, selecting, according to a duration of the dominant discharge, a 10-year period with a strong channel formation effect to calculate a time period average value of the sediment carrying capacity indicators corresponding to the dominant discharge;
step 32, calculating 5-year moving average values of the sediment carrying capacity indicators corresponding to the dominant discharge according to a hysteresis response principle of riverbed scouring and silting adjustment; and
step 33, drawing curves of the annual values, the 5-year moving average values and the time period average value of the sediment carrying capacity indicators corresponding to the dominant discharge;
step 4, determining and verifying the limit scouring state of the riverbed in the downstream river channel of the reservoir group;
step 41, analyzing the curves obtained in the step 33, in response to the curves of the annual values, the 5-year moving average values and the time period average value of the sediment carrying capacity indicators corresponding to the dominant discharge beginning to coincide at a coincided point, determining that a riverbed of a reach where the controlled hydrological station is located enters the limit scouring state from a time point corresponding to the coincided point; and in response to the curves of the annual values, the 5-year moving average values and the time period average value of the sediment carrying capacity indicators corresponding to the dominant discharge not coinciding, determining that scouring at the reach where the controlled hydrological station is located continues to develop and has not entered the limit scouring state;
step 42, comparing the near-stable time in the step 12 and the time point in the step 41, in response to the near-stable time and the time point being close, further determining that the riverbed enters the limit scouring state; and
step 43, obtaining a duration for the downstream river channel of the reservoir group to reach the limit scouring state; and
step 5, optimizing, in response to the riverbed entering the limit scouring state, an intake elevation of a water intake facility located on a riverbed of the downstream river channel of the
reservoir group to make a water intake guarantee rate of the water intake facility of at least 97%; or
controlling, in response to the riverbed doing not enter the limit scouring state, a safety depth of the water intake facility to make the water intake guarantee rate of the water intake facility at least be 97%.

2. The method for determining the limit scouring state of the riverbed in the downstream river channel of the reservoir group as claimed in claim 1, wherein the optimizing an intake elevation of a water intake facility located on a riverbed of the downstream river channel of the reservoir group to make a water intake guarantee rate of the water intake facility of at least 97% comprises:
calculating a submergence depth of a water intake port of the water intake facility; wherein the submergence depth is a vertical distance between the water intake port and a low-water level corresponding to a 97% water intake guarantee rate of the water intake facility; and
in response to the submergence depth being less than 1.0 meter (m), lowering the intake elevation of the water intake facility to 1.5 m below the low-water level to ensure the 97% water intake guarantee rate of the water intake facility.

3. The method for determining the limit scouring state of the riverbed in the downstream river channel of the reservoir group as claimed in claim 1, wherein the controlling a safety depth of the water intake facility to make the water intake guarantee rate of the water intake facility at least be 97% comprises:
lowering the intake elevation of the water intake facility to increase the safety depth to 2 m, to thereby ensure the 97% water intake guarantee rate of the water intake facility during a process of the riverbed continuing to scour to the limit scouring state.

4. The method for determining the limit scouring state of the riverbed in the downstream river channel of the reservoir group as claimed in claim 1, wherein the step 5 further comprises:
determining, in response to the riverbed entering the limit scouring state, coordinates of a main channel centerline in the downstream river channel based on a latest riverbed topography map and a navigation reference plane, and defining, according to the coordinates of the main channel centerline, a navigable channel having a navigable depth of at least 1.8 m and a width of at least 50 m; and
superposing the navigable channel onto a satellite image map to obtain a superposed image map; and displaying the superposed image map on a display screen to present information associated with the navigable channel, to thereby navigate a ship on the navigable channel ensure navigation safety of the ship.

5. A method for determining a limit scouring state of a riverbed in a downstream river
channel of a reservoir group, comprising:
step 1, measuring, by an assault boat equipped with a global navigation satellite system (GNSS) and a walking acoustic doppler current profiler (ADCP), discharge data and cross-sectional prototype observation data of the downstream river channel of the reservoir group at a frequency of no less than 100 times per year;
step 2, establishing a correlation between discharge of a cross-section of a controlled hydrological station and a sediment carrying capacity indicator of the cross-section of the controlled hydrological station;
step 21, calculating the sediment carrying capacity indicator U³/h of the cross-section of the controlled hydrological station, and establishing the correlation between the discharge of the cross-section of the controlled hydrological station and the sediment carrying capacity indicator of the cross-section of the controlled hydrological station to draw a correlation curve diagram of Q U³/h, wherein U represents an average discharge velocity of the cross-section, in m/s, h represents an average water depth of the cross-section, in m, and Q represents the discharge of the cross-section, in m³/s;
step 22, drawing a curve diagram of Q Q^{m}JP of the controlled hydrological station by using a Makkaveev method, wherein m represents a sediment transport coefficient, J represents a bed slope, P represents discharge frequency, m, J and P are dimensionless parameters, and Q^{m}JP comprehensively represents a sediment transport capacity of water flow; and calculating dominant discharge of a dam downstream river reach after storage and operation of the reservoir group; and
step 23, identifying, based on the correlation curve diagram of Q U³/h, sediment carrying capacity indicators corresponding to the dominant discharge year by year to obtain annual values of the sediment carrying capacity indicators;
step 3, calculating variation of the sediment carrying capacity indicator corresponding to the dominant discharge;
step 4, determining and verifying the limit scouring state of the riverbed in the downstream river channel of the reservoir group; and
step 5, determining, in response to the riverbed entering the limit scouring state, coordinates of a main channel centerline in the downstream river channel based on a latest riverbed
topography map and a navigation reference plane, and defining, according to the coordinates of the main channel centerline, a navigable channel having a navigable depth of at least 1.8 m and a width of at least 50 m; and
superposing the navigable channel onto a satellite image map to obtain a superposed image map; and displaying the superposed image map on a display screen to present information associated with the navigable channel, to thereby navigate a ship on the navigable channel ensure navigation safety of the ship.

6. The method for determining the limit scouring state of the riverbed in the downstream river channel of the reservoir group as claimed in claim 5, wherein the step 1 comprises:
step 11, measuring the discharge data and cross-sectional data of the controlled hydrological station in the downstream river channel of the reservoir group, and organizing measured discharge velocity data and water depth data; and
step 12, superimposing a cross-sectional change diagram of the controlled hydrological station according to the cross-sectional data, calculating a discharge area and an average riverbed elevation under a bankfull stage according to the measured discharge data, the measured discharge velocity data and the water depth data, drawing time-varying hydrographs of the discharge area and the average riverbed elevation under the bankfull stage, and preliminarily analyzing a scouring state of the cross-section and a near-stable time of the scouring state of the cross-section.

7. The method for determining the limit scouring state of the riverbed in the downstream river channel of the reservoir group as claimed in claim 5, wherein the step 3 comprises:
step 31, selecting, according to a duration of the dominant discharge, a 10-year period with a strong channel formation effect to calculate a time period average value of the sediment carrying capacity indicators corresponding to the dominant discharge;
step 32, calculating 5-year moving average values of the sediment carrying capacity indicators corresponding to the dominant discharge according to a hysteresis response principle of riverbed scouring and silting adjustment; and
step 33, drawing curves of the annual values, the 5-year moving average values and the time period average value of the sediment carrying capacity indicators corresponding to the dominant discharge.

8. The method for determining the limit scouring state of the riverbed in the downstream river channel of the reservoir group as claimed in claim 5, wherein the step 4 comprises:
step 41, analyzing the curves obtained in the step 33, in response to the curves of the annual values, the 5-year moving average values and the time period average value of the sediment carrying capacity indicators corresponding to the dominant discharge beginning to coincide at a coincided point, determining that a riverbed of a reach where the controlled hydrological station is located enters the limit scouring state from a time point corresponding to the coincided point;
and in response to the curves of the annual values, the 5-year moving average values and the time period average value of the sediment carrying capacity indicators corresponding to the dominant discharge not coinciding, determining that scouring at the reach where the controlled hydrological station is located continues to develop and has not entered the limit scouring state;
step 42, comparing the near-stable time in the step 12 and the time point in the step 41, in response to the near-stable time and the time point being close, further determining that the riverbed enters the limit scouring state; and
step 43, obtaining a duration for the downstream river channel of the reservoir group to reach the limit scouring state.

9. The method for determining the limit scouring state of the riverbed in the downstream river channel of the reservoir group as claimed in claim 5, wherein the step 5 further comprises:
calculating, in response to when the riverbed entering the limit scouring state, a submergence depth of a water intake port of the water intake facility; wherein the submergence depth is a vertical distance between the water intake port and a low-water level corresponding to a 97% water intake guarantee rate of the water intake facility; and
in response to the submergence depth being less than 1.0 m, lowering the intake elevation of the water intake facility to 1.5 m below the low-water level to ensure the 97% water intake guarantee rate of the water intake facility.

10. The method for determining the limit scouring state of the riverbed in the downstream river channel of the reservoir group as claimed in claim 5, wherein the step 5 further comprises:
lowering, in response to the riverbed doing not enter the limit scouring state, the intake elevation of the water intake facility to increase the safety depth to 2 m, to thereby ensure the 97% water intake guarantee rate of the water intake facility during a process of the riverbed continuing to scour to the limit scouring state.

11. A system for determining a limit scouring state of a riverbed in a downstream river channel of a reservoir group, configured to achieve the method as claimed in claim 1, comprising:
a data collection module, configured to collect the discharge data and the cross-sectional prototype observation data of the downstream river channel of the reservoir group;
a correlation establishment module, configured to establish the correlation between the discharge of the cross-section of the controlled hydrological station and the sediment carrying capacity indicator of the cross-section of the controlled hydrological station;
a calculation module, configured to calculate the variation of the sediment carrying capacity indicator corresponding to the dominant discharge; and
a determination module, configured to determine and verify the limit scouring state of the riverbed in the downstream river channel of the reservoir group.

12. A non-transitory computer-readable storage medium having a program code stored therein, wherein the program code is configured to be executed by a processor to implement steps of the method for determining the limit scouring state of the riverbed in the downstream river channel of the reservoir group as claimed in claim 1.
